(19) United States
(12) Patent Application Publication
(10) Pub. No.: US 2007/0214363 A1
(43) Pub. Date: Sep. 13, 2007

(54) Time stamp obtaining apparatus, time stamp obtaining method, and recording medium

(75) Inventor: Hiroshi Ishii, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/635,691

(22) Filed: Dec. 8, 2006

(30) Foreign Application Priority Data
Mar. 8, 2006 (JP) 2006-062761

(51) Int. Cl. H04L 9/00

(52) U.S. Cl. 713/178

(57) ABSTRACT

Disclosed is a time stamp obtaining apparatus that includes a memory unit to store one or a plurality of electronic data (image data), and a control unit to obtain one time stamp that relates to entirety of the electronic data in accordance with a hash value calculated from the entirety of the stored electronic data, and to store the obtained time stamp in connection with the electronic data in the memory unit.

### BACKGROUND OF THE INVENTION

1. Field of the Invention

The present invention relates to a time stamp obtaining apparatus, a time stamp obtaining method, and a recording medium.

2. Description of Related Art

Conventionally, technique to detect falsification using electronic signature such as Public Key Infrastructure (PKI) and the like are widely used. A service that can verify originality of data by utilizing certification and the like, that is issued by a third organization such as certificate authority, is provided.

In addition, a technique that applies the technique of afore-mentioned electronic signature to an image processing apparatus such as Multi Function Printer (MFP) and the like is proposed. For example, an apparatus that requests time certification (time stamp) of digital data of the manuscript that was read out, every time a manuscript is read out, and records the obtained time stamp in connection with the digital data, is disclosed (For example, refer to Japanese Laid-open Patent Application No. 2005-123980 (hereinafter referred to as patent document 1)).

However, concerning the afore-mentioned apparatus disclosed in the patent document 1, time stamp is obtained every time a manuscript is read out. Therefore, in a case where a plurality of manuscripts are read out, time stamp is obtained for digital data of each of the manuscripts, and thus there is a problem that a prolonged processing time is required. Especially, in a case where it is a service that is charged by the number of times time stamp is obtained, there is a problem that cost becomes high. In addition, since time stamp is stored (recorded) for the number of digital data of manuscript that is read out, there is a problem that amount of data increase.

### SUMMARY OF THE INVENTION

An object of the present invention is to provide a time stamp obtaining apparatus, a time stamp obtaining method, and a recording medium, that are capable to obtain time stamp efficiently.

According to an embodiment reflecting a first aspect of the present invention, a time stamp obtaining apparatus comprises a memory unit and a control unit, wherein the control unit conducts a control to: calculate one first hash value from one or a plurality of electronic data among electronic data stored in the memory unit; obtain one first time stamp that relates to the one or the plurality of electronic data, from which the first hash value is calculated, in accordance with the first hash value; and store the first time stamp in connection with the one or the plurality of electronic data that relates to calculation of the first hash value, in the memory unit.

According to an embodiment reflecting a second aspect of the present invention, a time stamp obtaining method comprises: first calculation step to calculate one first hash value from one or a plurality of electronic data among electronic data stored in a memory unit; first obtaining step to obtain one first time stamp that relates to the one or the plurality of electronic data, from which the first hash value is calculated, in accordance with the first hash value; and first storing step to store the first time stamp in connection with the one or the plurality of electronic data that relates to calculation of the first hash value, in the memory unit.

According to an embodiment reflecting a third aspect of the present invention, a computer readable recording medium stores a program, wherein the program causes a computer to execute a process comprising: first calculation step to calculate one first hash value from one or a plurality of electronic data among electronic data stored in a memory unit; first obtaining step to obtain one first time stamp that relates to the one or the plurality of electronic data, from which the first hash value is calculated, in accordance with the first hash value; and first storing step to store the first time stamp in connection with the one or the plurality of electronic data that relates to calculation of the first hash value, in the memory unit.

### BREIF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a view showing a structure of image processing system;

FIG. 2 is a view showing an internal structure of MFP;

FIG. 3 is a view showing an example of screen that relates to settings of obtaining time of time stamp;

FIG. 4A is a view showing an example of image data stored in a non-accessible storage area of a memory unit as a frame format;

FIG. 4B is a view showing an example of image data stored in a accessible storage area of the memory unit as a frame format;

FIG. 5 is view showing an internal structure of TSA server;

FIG. 6 is a flowchart showing procedure of read out processing;

FIG. 7 is a flowchart showing procedure of fixed time obtaining processing;

FIG. 8 is a flowchart showing procedure of settings changing processing;

FIG. 9 is a flowchart showing procedure of image data deletion processing;

FIG. 10 is a flowchart showing procedure of data validation processing;

FIG. 11 is a view showing an example of image data stored in the accessible storage area of the memory unit as a frame format;

FIG. 12 is a flowchart showing procedure of image data deletion processing according to second embodiment; and

FIG. 13 is a flowchart showing procedure of data validation processing according to the second embodiment.

### DETAILED DESCRIPTION OF THE PREFERRED EMBODIMENTS

Hereinafter, detailed description of the preferred embodiment of the present invention will be described with reference to figures. However, the scope of the invention is not limited to the example given in figures.

### First Embodiment

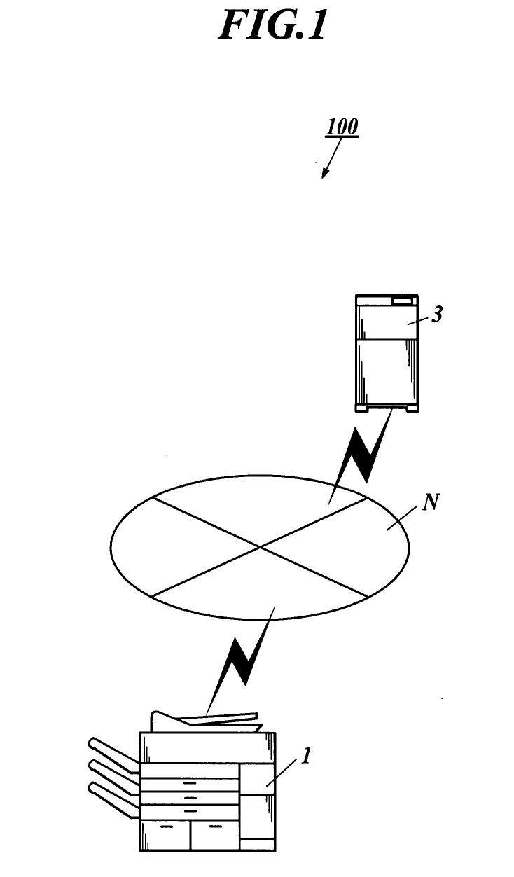

First of all, structure of image processing system 100 of the present embodiment is explained with reference to FIG. 1 through FIG. 5. As shown in FIG. 1, the image processing system 100 is provided with a Multi Function Printer/Peripheral (MFP) 1 as a time stamp obtaining apparatus according to the present invention, and a Time Stamp Authority (TSA) server 3. The MFP 1 and the TSA server 3 are connected through a network N so as to be capable to communicate with each other. Here, type and number of apparatus connected to the network N is not limited to the example given in FIG. 1. The MFP 1 may not be connected through the network N, and may be connected to the TSA server 3 directly (local connection).

The network N is a Wide Area Network (WAN) for example, and may include Local Area Network (LAN), and may be a structure that includes a telephone line network, an Integrated Services Digital Network (ISDN), a broadband communication network, an exclusive line, a mobile communication network, a communication satellite network, a Community Antenna TeleVision (CATV) network, an optical communication network, a wireless communication network, an internet service provider that is connected to these, and the like. Here, the data communication protocol between the MFP 1 and the TSA server 3 is not particularly limited. However, it is preferable to use a protocol that considers security, such as TLS/SSL, S/MIME, IPsec, and the like. An original protocol may also be used.

The MFP 1 conducts processing such as printing and the like, to image data that is sent from an information processing terminal (not shown) such as a personal computer and the like that is connected to the network N, or to image data that is read out by an image reading unit 20 described later. Here, image data is an electronic data that is printable by the MFP 1, and includes document data, still image data, and the like.

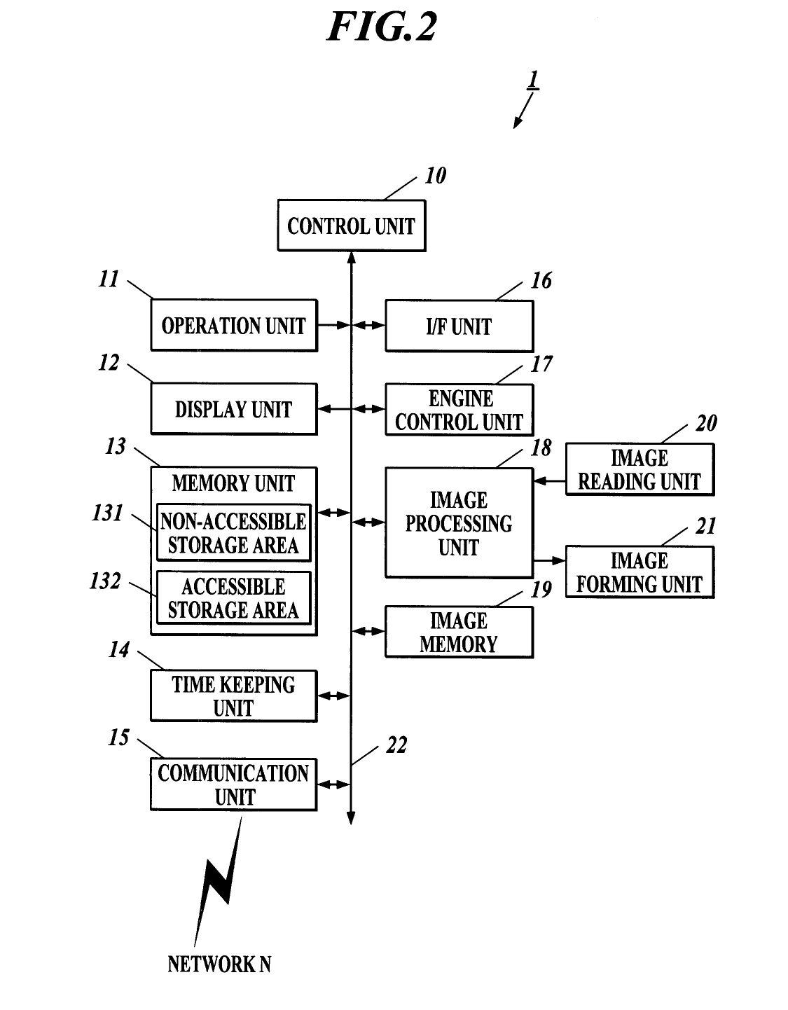

FIG. 2 is a block diagram showing an internal structure of the MFP 1. In this figure, MFP 1 is structured provided with a control unit 10, an operation unit 11, a display unit 12, a memory unit 13, a time keeping unit 14, a communication unit 15, an I/F unit 16, an engine control unit 17, an image processing unit 18, an image memory unit 19, an image reading unit 20, an image forming unit 21, and the like, and each unit is connected through a bus 22.

The control unit 10 includes a Central Processing Unit (CPU), Random Access Memory (RAM), and the like not shown. The CPU executes various kinds of processing by collaboration with various kinds of control programs stored in the memory unit 13 beforehand, and controls performance of each unit that structures the MFP 1, in an integrated manner.

In particular, the control unit 10 stores image data read out by the image reading unit 20 and image data sent from the information processing terminal (not shown) connected to the network N, in a non-accessible storage area 131 of the memory unit 13 described later. Here, in a case where user identification information such as user ID and the like is inputted by a user when the image data is inputted, this user identification information is stored in connection with the image data when the image data is stored.

In addition, in accordance with instruction information to instruct obtaining of time stamp (hereinafter referred to as obtaining instruction information) inputted through the operation unit 11 and the like, or in accordance with a predetermined time information inputted from the time keeping unit 14, the control unit 10 reads out (extracts) image data that have been stored in the non-accessible storage area 131 of the memory unit 13 before input of such obtaining instruction information or time information. Subsequently, the control unit 10 integrates this image data into one data by a predetermined integration manner. Further, the control unit 10 calculates one hash value that relates to the entire image data by applying a predetermined hash function to this integrated data. This hash value is sent to the TSA server 3, and one time stamp is obtained from the TSA server 3. Then, the control unit 10 stores the obtained time stamp and the image data that relates to the time stamp, in connection with each other, in the accessible storage area 132 of the memory unit 13 described later. Here, the hash function is one-way function such as Message Digest 5 (MD 5) and the like. Concerning such function, a certain input can be easily converted and outputted, however, it is difficult or impossible to obtain the input from the output, by inverse direction.

In addition, in accordance with instruction information, which is inputted through the operation unit 11 and the like, to delete image data stored in the accessible storage area 132, the control unit 10 compensates as if the image data is deleted from the accessible storage area 132, by applying fictitious deleted information to the image data that is instructed. Here, the fictitious deleted information is instruction information such as flag information, which is predetermined to compensate as if it is deleted. For example, image data that is applied with the fictitious deleted information is controlled in a state that is non-accessible, or invisible. Application of this fictitious deleted information may be stored in connection with the image data, or may be stored in the header portion of the image data.

The control unit 10 controls the image processing unit 18 and the image forming unit 21 and thus prints the image data stored in the accessible storage area 132 of the memory unit 13 described later, to a recording medium such as recording paper and the like.

In accordance with an instruction from a user, the control unit 10 obtains TSA public key (described later) from the TSA server 3 which relates to generation of time stamp that is stored in connection with a particular image data. Hash value is decoded from the time stamp by using this TSA public key. Then, time certification of image data is conducted by comparing this hash value with a hash value that is re-calculated from each job itself. Here, time certification means verification of originality (integrity) and existence of the image data, in other words, verification that a valid image data existed at a predetermined time.

The operation unit 11 is provided with various kinds of input keys and the like, receives information that is inputted by the user as input signal, and outputs the input signal to the control unit 10. The display unit 12 is structured with Liquid Crystal Display (LCD) and the like, and displays various kinds of information in accordance with a display signal from the control unit 10. The display unit 12 may structure a touch panel combined with the operation unit 11.

The user of the MFP 1 is capable to input obtaining instruction information to instruct obtaining of time stamp through this operation unit 11. In addition, the user of the MFP 1 is capable to set various kinds of settings related to obtaining of time stamp, such as time and date to obtain time stamp (hereinafter referred to as obtaining time) and the like, through this operation unit 11. Here, contents of settings that are set are stored in the memory unit 13 or in the RAM not shown as the setting information, and the control unit 10 conducts control in accordance with this setting information.

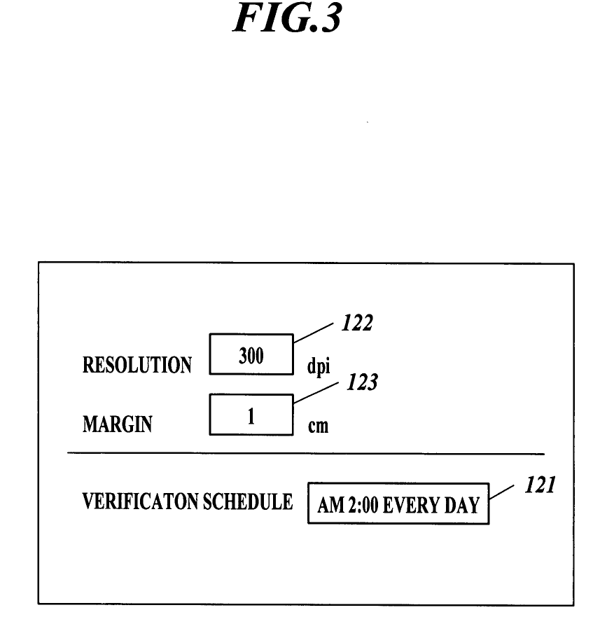

FIG. 3 is a view showing an example of screen that relates to setting obtaining time of time stamp. As shown in FIG. 3, a state where “AM 2:00 Every Day” is set as the obtaining time to the setting item 121 that corresponds to “verification schedule”, is shown. In this case, for each occasion time information that indicates AM 2:00 is inputted from the time keeping unit 14, the control unit 10 calculates hash value for entire image data that have been stored in the accessible storage area 132 of the memory 13 until input of this time information, and obtains time stamp from the TSA server 3 in accordance with this hash value. Here, obtaining time that is allowed to be set is not limited to the example shown in figure. For example, it may be set so that time stamp is obtained once a month or once a week, or may be set so that time stamp is obtained every other day or twice, before noon and afternoon. In FIG. 3, 122 is a setting item that relates to resolution when manuscript image is read out by the image reading unit 20, and 123 is a setting item that relates to page margins of a recording paper when image is formed by the image forming unit 21, and are set to “300 dpi” and “1 cm” respectively, through the operation unit 11 and the like.

The user of the MFP 1 is capable to instruct deletion of a particular image data, among image data stored in the memory unit 13, through this operation unit 11.

In addition, the user of the MFP 1 is capable to instruct necessity to obtain time stamp in advance or as needed, through the operation unit 11. The setting information, that relates to contents of settings that is instructed, is stored in the memory unit 13 or the RAM not shown, and the control unit 10 conducts control in accordance with this setting information. Here, in the present embodiment, settings of necessity to obtain time stamp can be conducted by the user, however, it is not limited to such embodiment. It may be set so that obtaining of time stamp is always conducted, or only a privileged user such as system administrator of the MFP 1 and the like may be made capable to set necessity to obtain time stamp.

Here, the afore-mentioned instruction input that relates to obtaining of time stamp and deletion of image data are not only inputted through the operation unit 11. It may also be inputted from an information processing terminal (not shown) such as a personal computer and the like, that is connected to the network N.

The memory unit 13 is provided with a magnetic or optical recording medium, or a non-volatile recording medium that is structured with a semi-conductor memory, and stores program necessary for performance of MFP 1 and data relating to execution of the program. Here, this recording medium may be structured so that it is detachable to the MFP 1.

Here, storage area of the memory unit 13 is segmented to a storage area that is controlled so as to be non-accessible by the user (hereinafter referred to as non-accessible storage area 131) and a storage area that is controlled so as to be accessible by the user (hereinafter referred to as accessible storage area 132), beforehand. Image data read out by the image reading unit 20, and one or a plurality of image data sent from the information processing terminal (not shown) that is connected to the network N, are stored in the non-accessible storage area 131 under control of the control unit 10. In addition, the memory unit 13 stores time stamp obtained from the TSA server 3 and image data that relates to the time stamp in connection with each other in the accessible storage area 132, under control of the control unit 10.

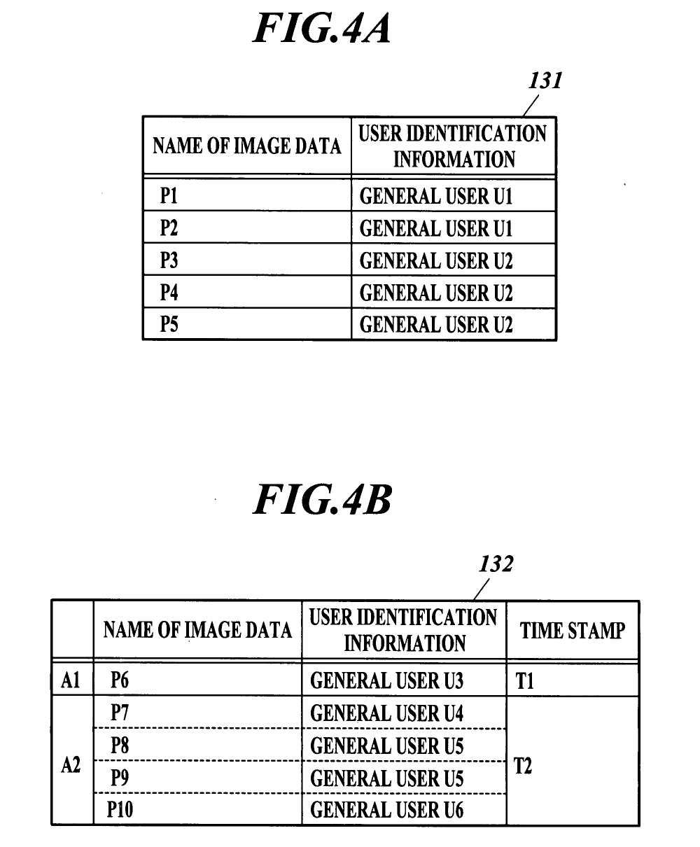

FIGS. 4A and 4B are views showing example of image data stored in the memory unit 13 as a frame format, wherein FIG. 4A shows image data stored in the non-accessible storage area 131, and FIG. 4B shows image data stored in the accessible storage area 132.

As shown in FIG. 4A, in the non-accessible storage area 131, each of the image data P1 through P5 is stored in a state in which user identification information (general user U1, U2) of a user who conducted input of each image data is stored in connection with each of the image data P1 through P5, respectively. Here, in the present embodiment, image data and user identification information are stored in connection with each other in a table form, however, it is not limited to this embodiment. For example, user identification information may be attached to a header portion and the like of the image data for storage.

As shown in FIG. 4B, in the accessible storage area 132, image data P6 through P10 (user identification information: general user U3 through U6) and time stamp T1, T2 are stored in connection with each other. Here, A1 indicates a group in which one image data P6 and one time stamp T1 are stored in connection with each other, and A2 indicates a group in which each of the four image data P7 through P10 and one time stamp T2 are stored in connection with each other. Here, in the present embodiment, image data and user identification information are stored in connection with each other in a table form, however, it is not limited to this embodiment. For example, user identification information may be attached to a header portion and the like of the image data for storage. In such case, it is preferable to conduct calculation of hash value for data portion, which is header portion eliminated from the entire data included in each image data.

Further, in the present embodiment, access to image data that has not yet obtained time stamp was controlled by segmenting the storage area of the memory unit 13 into a region that is accessible by the user and a region that is non-accessible by the user. However, it is not limited to this embodiment. Access from the user may be made prohibited by encoding the image data, which has not yet obtained time stamp, with a predetermined encryption key. In such case, image data that obtained time stamp is decrypted by a predetermined decryption key, and then stored in connection with the time stamp that corresponds to the image data. Further, concerning image data that is instructed explicitly not to conduct obtaining of time stamp, through the operation unit 11 or not shown information processing terminal connected to the network N (hereinafter referred to as operation unit 11 and the like), it is directly stored in the accessible storage area 132 without going through the non-accessible storage area 131.

The time keeping unit 14 times the present time in accordance with a clock signal from a crystal oscillator not shown, which always transmits constant frequency. The timed time information is outputted to the control unit 10. Here, in the present embodiment, the time keeping unit 14 itself conducts timing by crystal oscillator, however, it is not limited to this embodiment. For example, time information may be obtained from an external time keeping apparatus such as Network Time Protocol (NTP) and the like, through the network N.

The communication unit 15 is a Modulator/DEModulator (MODEM), a terminal adapter, a LAN adapter, and the like, and conducts communication control of various kinds of information exchanged among other apparatuses (such as TSA server 3 and the like) that are connected to the network N, under the control of the control unit 10. In particular, the communication unit 15 sends hash value that relates to obtaining of time stamp to the TSA server 3, and receives time stamp sent from the TSA server 3.

The I/F unit 16 is a communication interface that conducts data communication with other apparatuses, and is structured with a universal serial bus (USB), IEEE 1284, IEEE 1394, PCMCIA, and the like.

The engine control unit 17 controls performance of the image forming unit 21 that relates to image forming (printing) in an integrated manner, under the control of the control unit 10.

The image processing unit 18 generates image data for printing (bit map data) from the image data stored in the accessible storage area 132 of the memory unit 13, and stores it in the image memory 19, under the control of the control unit 10.

The image memory 19 is structured with a Synchronous Dynamic Random Access Memory (SDRAM) and the like, and stores image data for printing that is generated by the image processing unit 18.

The image reading unit 20 is structured provided with a scanner in the lower portion of a contact glass, on which the manuscript image is placed, and reads out the manuscript image. The scanner is structured with a light source, a Charge Coupled Device (CCD) image sensor, and the like. The manuscript image is read out by focusing reflected light of light that is illuminated and scanned from the light source to the manuscript and then conducting photoelectric conversion. Subsequently the read out manuscript image is converted into digital image data by A/D converter, and is outputted to the control unit 10. Here, manuscript image is not limited to figures, pictures, and the like, and is a general idea that includes text document such as letters, symbols, and the like.

The image forming unit 21 is a printer of ink jet type, laser type, dot impact type, and the like. The image forming unit 21 prints the image data for printing on a recording medium such as recording paper and the like, under the control of the control unit 10.

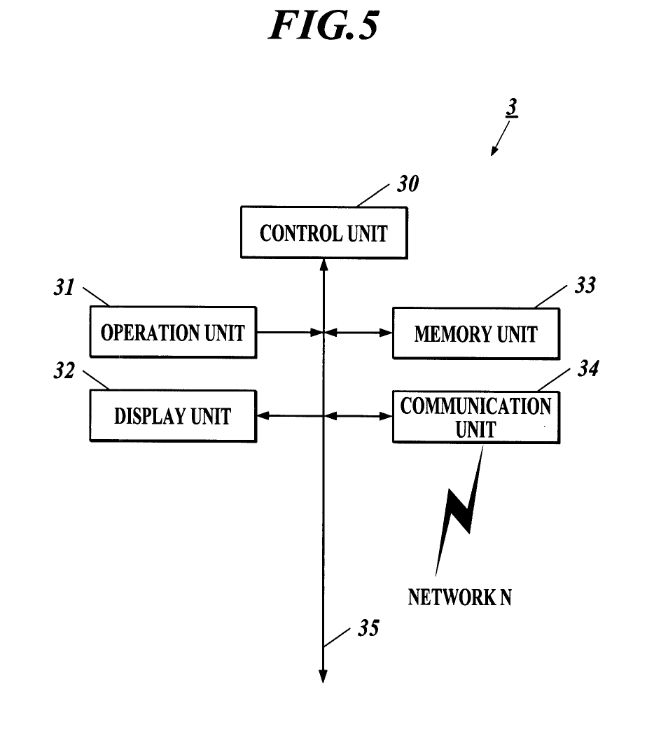

Next, description on the TSA server 3 will be given with reference to FIG. 5.

The TSA server 3 is a public CA, and is a server apparatus that issues time stamp used for time verification in accordance with hash value that is sent from the MFP 1 through the network N, and provides the time stamp to the MFP 1.

FIG. 5 is a block diagram of internal structure of the TSA server 3. According to this figure, the TSA server 3 is structured provided with a control unit 30, an operation unit 31, a display unit 32, a memory unit 33, a communication unit 34, and the like, and each unit is connected through a bus 35.

The control unit 30 includes a CPU, RAM, and the like not shown, and the CPU executes various kinds of processing by collaboration with various kinds of control programs that are stored in the memory unit 33 beforehand, by using a predetermined region of the RAM as work area. Thus the CPU controls performance of each unit that structures the TSA server 3 in an integrated manner.

In particular, in a case where hash value is received from the MFP 1, the control unit 30 generates electronic signature by encrypting this hash value and time information that indicates the receiving time of the hash value, with a secret key for electronic signature (hereinafter referred to as TSA secret key), and sends this electronic signature as a time stamp to the MFP 1. Here, in this time stamp generated, destination information to specify connection destination of the TSA server 3 which manages the time stamp, such as IP address, MAC address, and the like, are at least included.

In a case where public key request information to request public key that corresponds to the afore-mentioned TSA secret key (hereinafter referred to as TSA public key) is received from the MFP 1, the control unit 30 sends this TSA public key to the MFP 1. At the MFP 1 side, the MFP 1 is capable to conduct time certification to verify that the image data with the hash value that relates to generation of the time stamp existed at the time of receiving, according to the TSA public key and the time stamp.

The operation unit 31 is provided with input key and the like, receives information that is inputted by the user as input signal, and outputs the input signal to the control unit 30. The display unit 32 is structured with LCD and the like, and displays various kinds of information in accordance with display signal from the control unit 30.

The memory unit 33 is provided with a magnetic or optical recording medium, or a non-volatile recording medium that is structured with a semi-conductor memory, and stores program necessary for performance of TSA server 3 and data relating to execution of the program. Here, this recording medium may be structured so that it is detachable to the TSA server 3.

The communication unit 34 is a MODEM, a terminal adapter, a LAN adapter, and the like, and conducts communication control of various kinds of information exchanged among other apparatuses (such as MFP 1 and the like) that are connected to the network N, under the control of the control unit 30. In particular, the communication unit 30 receives hash value sent from the MFP 1, and sends time stamp that is generated in connection with this hash value to the MFP 1.

Hereinafter, overall performance of the MFP 1 concerning the image processing system 100 as afore-mentioned will be described.

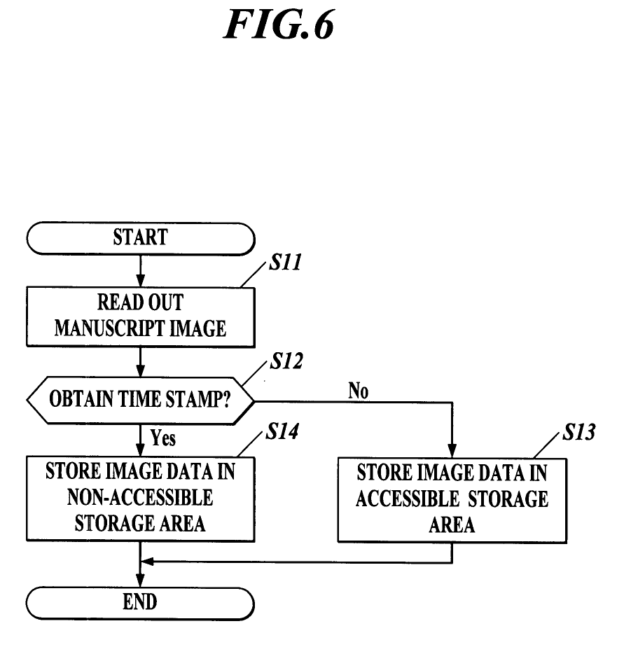

First of all, procedure of processing when manuscript image is read out by the MFP 1 (hereinafter referred to as read out processing) is described with reference to FIG. 6. Here, each of the processing within the read out processing indicates processing that is executed by collaboration of predetermined program stored in the memory unit 13, under the control of the control unit 10.

First of all, in a case where manuscript image is read out by the image reading unit 20 (step S11), the control unit 10 determines necessity of time stamp obtaining in accordance with the setting information stored in the memory unit 13 or the RAM (not shown) (step S12). Here, in a case where it is set so as not to obtain time stamp (step S12; No), image data generated by being read out by the image reading unit 20 is stored in the accessible storage area 132 of the memory unit 13 (step S13), and the present processing is concluded.

On the other hand, in step S12, in a case where it is set so as to obtain time stamp (step S12; Yes), image data generated by being read out by the image reading unit 20 is stored in the non-accessible storage area 131 of the memory unit 13 (step S14), and the present processing is concluded.

As described above, since image data that is instructed to obtain time stamp is stored in the non-accessible storage area 131, access to the image data from the external is controlled so as to be prohibited. Therefore, operation such as falsification or deletion of data before time stamp is obtained, can be prevented.

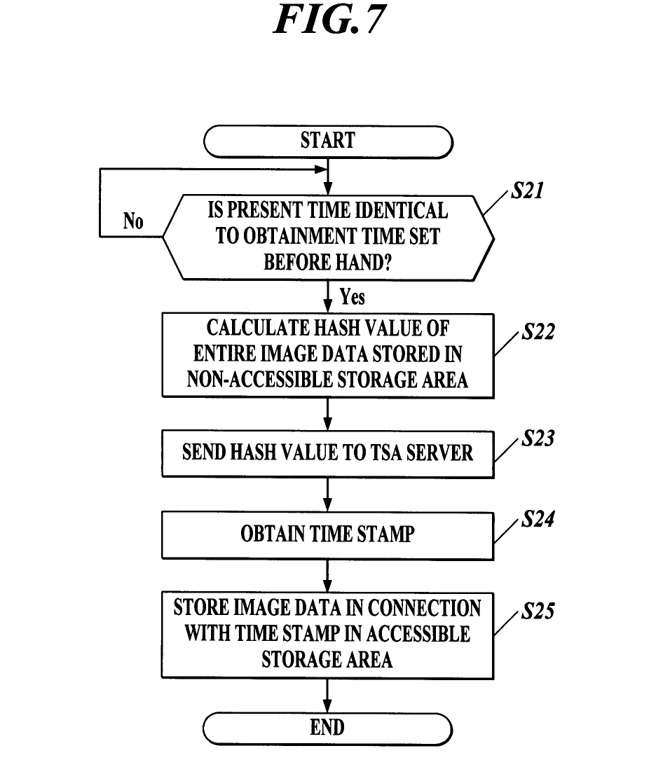

Next, procedure of processing when obtaining time stamp at obtaining time that is set by a user (hereinafter referred to as fixed time obtaining processing) is described with reference to FIG. 7. Here, each of the processing within the fixed time obtaining processing indicates processing that is executed by collaboration of predetermined program stored in the memory unit 13, under the control of the control unit 10.

First of all, the control unit 10 conducts stand by until the time indicated by time information inputted from the time keeping unit 14 becomes identical to the obtaining time that is set beforehand (step S21; No). Then, in a case where the control unit 10 determines that the present time indicated by time information and the obtaining time is identical (step S21; Yes), all of the image data, that have been stored in the non-accessible storage area 131 of the memory unit 13 until this obtaining time, is read out (extracted), and one hash value that is in correspondence to the entire image data is calculated (step S22). Subsequently, the calculated hash value is sent to the TSA server 3 (step S23), and one time stamp is obtained from the TSA server 3 (step S24).

The control unit 10 moves the image data stored in the non-accessible storage area 131 of the memory unit 13 to the accessible storage area 132, stores this image data in connection with the time stamp obtained from the TSA server 3 (step S25), and concludes the present processing.

As described above, hash value for entire image data, that have been stored in the non-accessible storage area 131 until the obtaining time set beforehand, is calculated and one time stamp that relates to the entire image data is obtained in accordance with this hash value. Therefore, time stamp that relates to a plurality of image data can be obtained efficiently, thus time and cost required to obtain time stamp can be reduced.

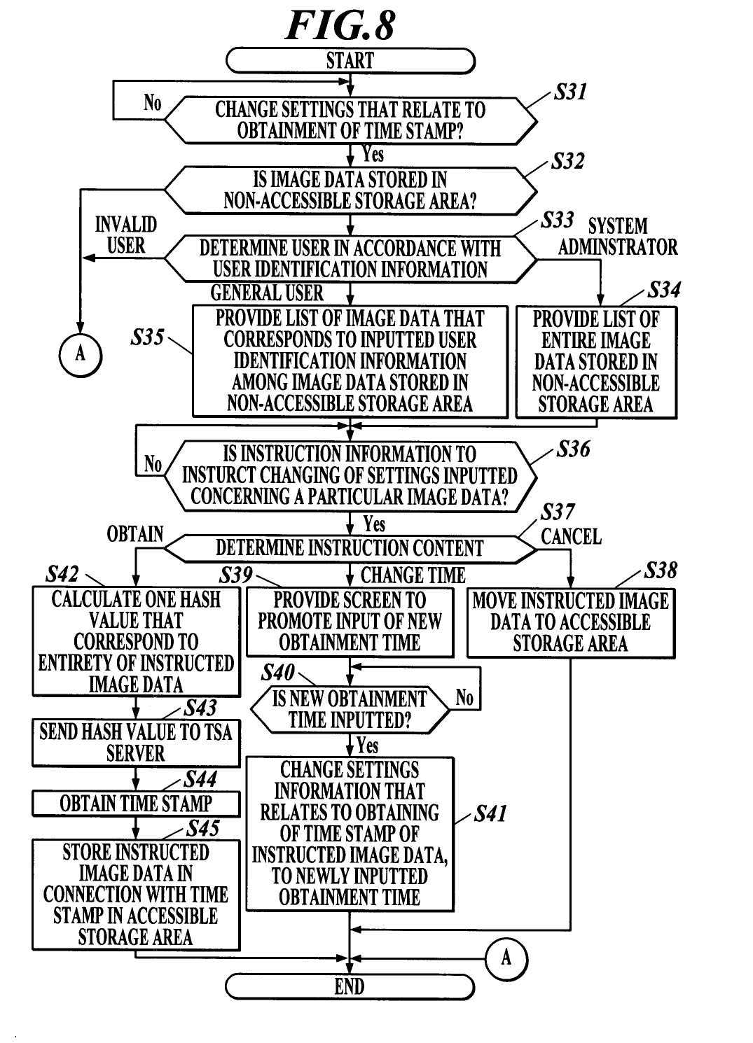

Next, procedure of processing when changing settings that relates to obtaining of time stamp in accordance with instruction from the user (hereinafter referred to as settings changing processing) is described with reference to FIG. 8. Here, each of the processing within the settings changing processing indicates processing that is executed by collaboration of predetermined program stored in the memory unit 13, under the control of the control unit 10.

As an assumption of the present processing, MFP 1 is operated by a system administrator as a privileged user and a general user, and user identification information such as user ID that is capable to identify each user, password, and the like, is stored in the memory unit 13 as certification information. Further, it is assumed that user identification information of each user is inputted from the operation unit 11 and the like, before the present processing is started.

First of all, the control unit 10 conducts standby until instruction information to conduct changing of settings that relates to obtaining of time stamp is inputted from the operation unit 11 and the like (step S31; No). Then, in a case where the control unit 10 affirms input of this instruction information (step S31; Yes), the control unit 10 determines whether image data is stored in the non-accessible storage area 131 of the memory unit 13 or not. In a case where it is determined that image data is not stored in the non-accessible storage area 131 of the memory unit 13 (step S32; No), the present processing is concluded immediately.

On the other hand, in a case where it is determined in step S32 that image data is stored in the non-accessible storage area 131 of the memory unit 13 (step S32; Yes), the control unit 10 compares the user identification information inputted beforehand with the certification information of the memory unit 13, and thus identifies the user (step S33). Then, in a case where it is identified as the system administrator (step S33; system administrator), the control unit 10 provides a list of all the image data stored in the non-accessible storage area 131, in a form that is referable by the system administrator, such as by displaying it on the display unit 12 (step S34), and moves on to step 36.

On the other hand, in a case where it is identified in step S33 as the general user (step S33; general user), only image data that corresponds to the user identification information of this general user, among the image data stored in the non-accessible storage area 131, is provided in a form that is referable by this general user, such as by displaying it on the display unit 12 (step S35), and moves on to step S36. Here, in a case where it is determined in step S33 that it is neither the system administrator nor the general user (step S33; invalid user), the control unit 10 determines that it is an operation by an invalid user, and concludes the present processing immediately.

In the following step S36, the control unit 10 conducts standby until instruction information to instruct changing settings that relate to obtaining of time stamp concerning a particular image data, among the image data provided in a form that is referable by each user, is inputted (step S36; No). Here, the number of image data that is specified is regardless.

In a case where the control unit 10 affirms in step S36 that instruction information is inputted (step S36; Yes), it determines the changing content that is instructed by the instruction information. In a case where changing content to cancel obtaining of time stamp is inputted (step S37; cancel), the image data that is instructed by the user is cancelled from the subject to obtain time stamp, by moving the storage area of the image data from non-accessible storage area 131 to the accessible storage area 132 (step S38), and concludes the present processing.

On the other hand, in step S37, in a case where changing content to change obtaining time of time stamp is inputted (step S37; change time), a screen to promote changing the obtaining time is provided in a form that is referable by the user, such as by displaying the screen on the display unit 12 (step S39), and conducts standby until a new obtaining time is inputted (step S40; No). Then, in a case where it is affirmed that the new obtaining time is inputted (step S40; Yes), the control unit 10 changes the setting information that relates to obtaining of time stamp, concerning the image data instructed by the user, to the obtaining time that is newly inputted (step S41), and concludes the present processing.

In this case, in the event that the time indicated by the time information inputted from the time keeping unit 14 becomes identical to the obtaining time that was changed in step S40, the control unit 10 calculates hash value for entire image data that is specified, and sends this hash value to the TSA server 3. Thus, one time stamp that relates to the entire image data that is specified is obtained from the TSA server 3.

On the other hand, in step S37, in a case where changing content to conduct obtaining of time stamp immediately is inputted (step S37; obtain), the control unit 10 reads out (extracts) image data, that is instructed by the user, from the non-accessible storage area 131, calculates one hash value that corresponds to this entire image data that is specified (step S42), and sends this calculated hash value to the TSA server 3 (step S43). Thus, one time stamp is obtained from the TSA server 3 (step S44). Subsequently, the control unit 10 moves the image data that is specified by the user to the accessible storage area 132, and stores each of the image data in connection with the time stamp obtained from the TSA server 3 (step S45), and concludes the present processing.

As described above, hash value for the entire image data that have been stored in the non-accessible storage area 131 until the instruction information to instruct obtaining of time stamp is inputted, or hash value for the entire image data that is specified by the instruction from the user, is calculated. Then, one time stamp that relates to the entire image data is obtained in accordance with this hash value. Therefore, user's convenience can be provided as well as time stamp that relates to a plurality of electronic data can be obtained efficiently, thus time and cost required to obtain time stamp can be reduced.

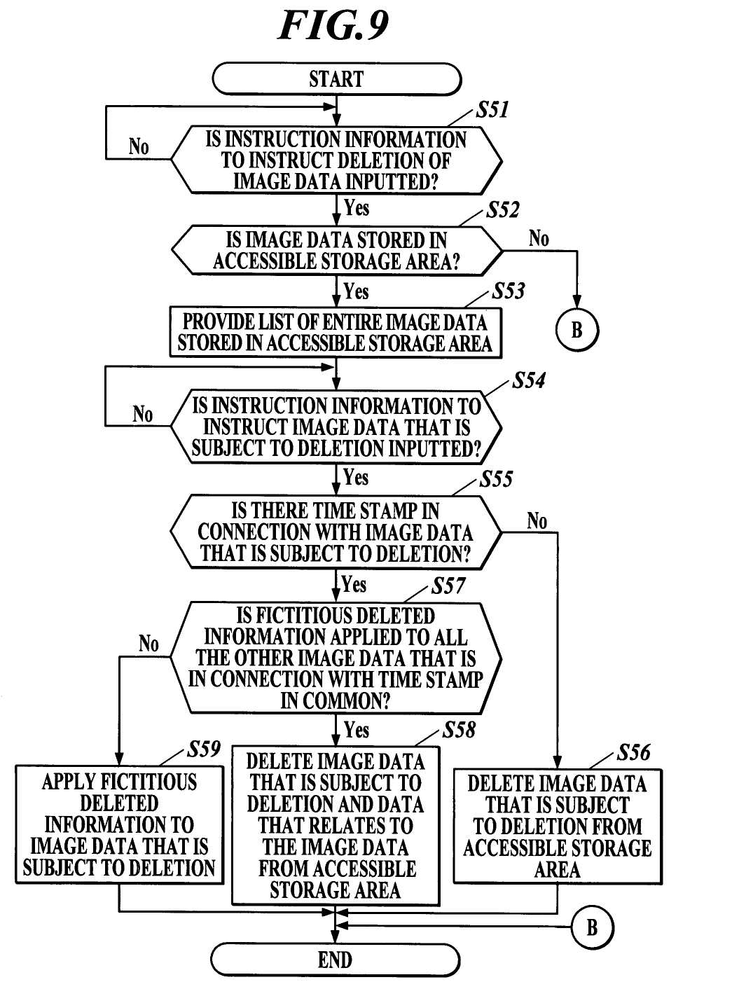

Next, procedure of processing when deleting image data that is stored in the accessible storage area 132 in accordance with the instruction from the user (hereinafter referred to as image data deletion processing) is described with reference to FIG. 9. Here, each of the processing within the image data deletion processing indicates processing that is executed by collaboration of predetermined program stored in the memory unit 13, under the control of the control unit 10.

First of all, the control unit 10 conducts standby until instruction information to conduct deletion of image data, that is stored in the accessible storage area 132, is inputted from the operation unit 11 and the like (step S51; No). Then, in a case where the control unit 10 affirms that this instruction information is inputted (step S51; Yes), it determines whether image data is stored in the accessible storage area 132 of the memory unit 13 or not. In a case where it is determined that there is no image data stored in the accessible storage area 132 (step S52; No), the present processing is concluded immediately.

On the other hand, in a case where it is determined in step S52 that image data is stored in the accessible storage area 132 (step S52; Yes), the control unit 10 provides a list of all the image data stored in the accessible storage area 132, in a form that is referable by the user, such as by displaying it on the display unit 12 (step S53). Here, concerning image data that is applied with the fictitious deleted information, it is provided in a manner so that it seems to be deleted, such as by displaying indication of “deleted”, or by not displaying it.

Subsequently, the control unit 10 conducts standby until instruction information to specify image data that is subject to deletion, among the list of image data provided to the user in the referable manner (step S54; No). Then, in a case where input of this instruction information is affirmed (step S54; Yes), the control unit 10 determines whether time stamp is provided in connection with the image data that is subject to deletion or not. In a case where it is determined that time stamp is not provided in connection (step S55; No), this image data is deleted from the accessible storage area 132 (step S56), and concludes the present processing.

On the other hand, in a case where it is determined in step S55 that time stamp is provided in connection with the image data that is subject to deletion (step S55; Yes), the control unit 10 determines whether fictitious deleted information is applied to all the other image data that are in connection with this time stamp or not (step S57).

In a case where it is determined in step S57 that fictitious deleted information is applied to all the other image data (step S57; Yes), the control unit 10 deletes the image data that is subject to deletion as well as data that relates to the image data that is subject to deletion (time stamp and other image data that is in connection with the time stamp), from the accessible storage area 132 (step S58), and concludes the present processing. Therefore, since image data and time stamp that became unneeded can be deleted, memory capacity can be used efficiently.

On the other hand, in a case where it is determined in step S57 that fictitious deleted information is not applied to all the other image data (step S57; No), the control unit 10 applies fictitious deleted information to the image data that is subject to deletion (step S59), and concludes the present processing.

As described above, in a case where instruction information to instruct deletion of a particular image data is inputted through the operation unit 11 and the like, it is compensated as if the image data that is instructed to be deleted is deleted. Therefore, convenience of the user can be provided. In addition, since hash value can be re-calculated for the entire electronic data that is in connection with this time stamp, from the image data that is instructed to be deleted and other image data that is in connection with the time stamp which is in common with the image data that is instructed to be deleted, the entire image data can be validated in accordance with this hash value.

Here, in the afore-mentioned image data deletion processing, image data that is selectable so as to be subject to deletion may be restricted in accordance with the user identification information inputted from the user. In such case, it is preferable that the system administrator is capable to select all of the image data, that is stored in the accessible storage area 132, so as to be subject to deletion, and it is preferable that the general user is capable to select image data, that relates to the user identification information of this general user, so as to be subject to deletion.

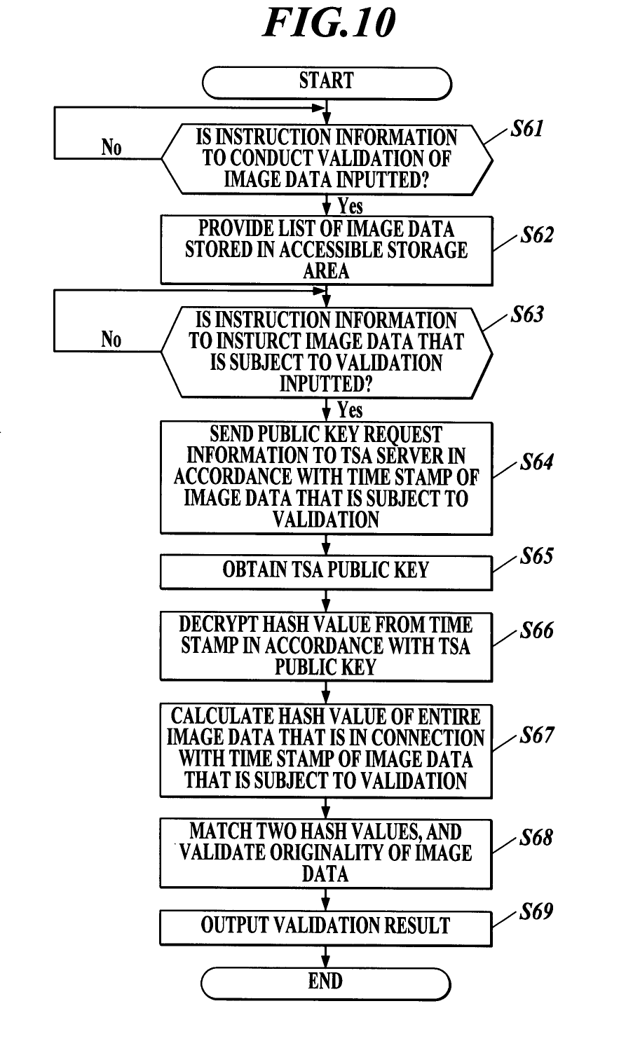

Next, a procedure of processing when validation of image data is conducted at the MFP 1 (hereinafter referred to as data validation processing) is described with reference to FIG. 10. Here, each of the processing within the data validation processing indicates processing that is executed by collaboration of predetermined program stored in the memory unit 13, under the control of the control unit 10.

First of all, the control unit 10 conducts standby until instruction information to conduct validation of image data is inputted from the operation unit 11 and the like (step S61; No). Then, in a case where the control unit 10 affirms that the instruction information is inputted (step S61; Yes), a list of image data stored in the accessible storage area 132 of the memory unit 13 is provided in a form that is referable by the user, such as by displaying it on the display unit 12 (step S62). Here, concerning image data that is applied with the fictitious deleted information, it is provided in a manner so that it seems to be deleted, such as by displaying indication of “deleted”, or by not displaying it.

Subsequently, the control unit 10 conducts standby until instruction information to specify image data that is subject to validation is inputted from the operation unit 11 and the like (step S63; No). Then, in a case where the control unit 10 affirms that instruction information is inputted (step S63; Yes), the control unit 10 sends public key request information (step S64) to request TSA public key to the TSA server 3, which is the destination information included in the time stamp of the image data that is subject to validation. Thus, TSA public key is obtained from this TSA server 3 (step S65).

The control unit 10 decrypts hash value (step S66) from the time stamp of the image data that is subject to validation, by the obtained TSA public key, as well as re-calculates hash value (step S67) by applying hash function to the entire image data that is in connection with this time stamp. Then, the control unit 10 validates originality of the image data that is subject to validation (step S68) by matching these two hash values. The validation result is outputted in a manner that is referable by the user (step S69), through the display unit 12, the image forming unit 21, and the like, and the present processing is concluded.

As described above, since the electronic data stored in connection with the time stamp is validated in accordance with the time stamp, time certification of the entire electronic data can be conducted at one time.

As described above, according to the present embodiment, one time stamp that relates to the entire image data is obtained in accordance with the hash value that is calculated from one or the entirety of a plurality of image data that is stored in the non-accessible storage area 131. Therefore, time stamp that relates to a plurality of image data can be obtained efficiently, and thus time and cost required to obtain time stamp can be reduced.

Here, in a case where printing of image data stored in the accessible storage area 132 is instructed by the user, the afore-mentioned data validation processing may be conducted together. In such case, validation result of the image data may be outputted in an overlapped manner with the image that is print outputted. Further, in a case where it is determined as a result of validation that originality is not maintained, it may be controlled so as not to conduct printing.

In a case where validation of a particular image data is instructed individually from the user, validation is conducted for the entire image data that is in connection with the time stamp of the image data that is subject to validation, and this validation result is outputted as a validation result of the image data that is subject to validation.

### Second Embodiment

Next, second embodiment of the present invention is described. Here, to simplify the description, the same reference numeral is used for the same element as the afore-described first embodiment, and precise description is omitted.

In accordance with instruction information to instruct obtaining of time stamp (hereinafter referred to as obtaining instruction information) inputted through the operation unit 11 and the like, or in accordance with a predetermined time information inputted from the time keeping unit 14, the control unit 10 of MFP 1 according to the present embodiment, reads out (extracts) image data that have been stored in the non-accessible storage area 131 of the memory unit 13 until input of such obtaining instruction information or time information. Subsequently, the control unit 10 calculates individual hash value for each image data by applying a predetermined hash function to each of the image data. Then, the control unit 10 integrates this individual hash value into one data by a predetermined integration manner. Further, the control unit 10 calculates one hash value that relates to the entire image data by applying a predetermined hash function to this integrated data. This hash value is sent to the TSA server 3, and one time stamp is obtained from the TSA server 3. Then, the control unit 10 stores the obtained time stamp, the image data that relates to the time stamp, and the individual hash value for the image data, in connection with each other, in the accessible storage area 132 of the memory unit 13 described later.

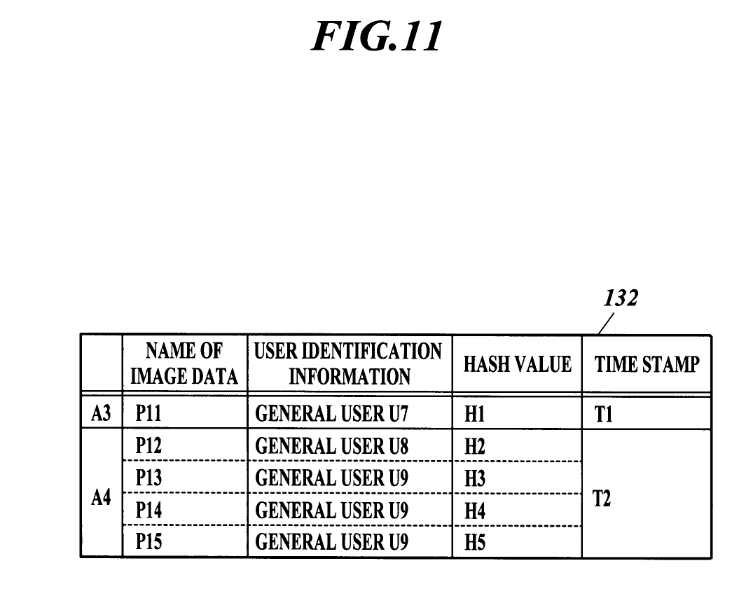

FIG. 11 is a view showing an example of image data stored in the accessible storage area 132 of the memory unit 13 as a frame format. As shown in FIG. 11, image data P11 through P15 (user identification information U7 through U9), individual hash value H1 through H5 of the image data, and time stamp T3, T4 are stored in connection with each other. Here, A3 indicates a group in which one image data P11, individual hash value H1 of the image data P11, and one time stamp T3 are stored in connection with each other, and A4 indicates a group in which each of the four image data P12 through P15, each of the individual hash value H2 through H5 of the image data, and one time stamp T4 are stored in connection with each other.

In addition, in accordance with instruction information which is inputted through the operation unit 11 and the like, to instruct deletion of image data that is stored in the accessible storage area 312, the control unit 10 deletes the specified image data from the accessible storage area 132.

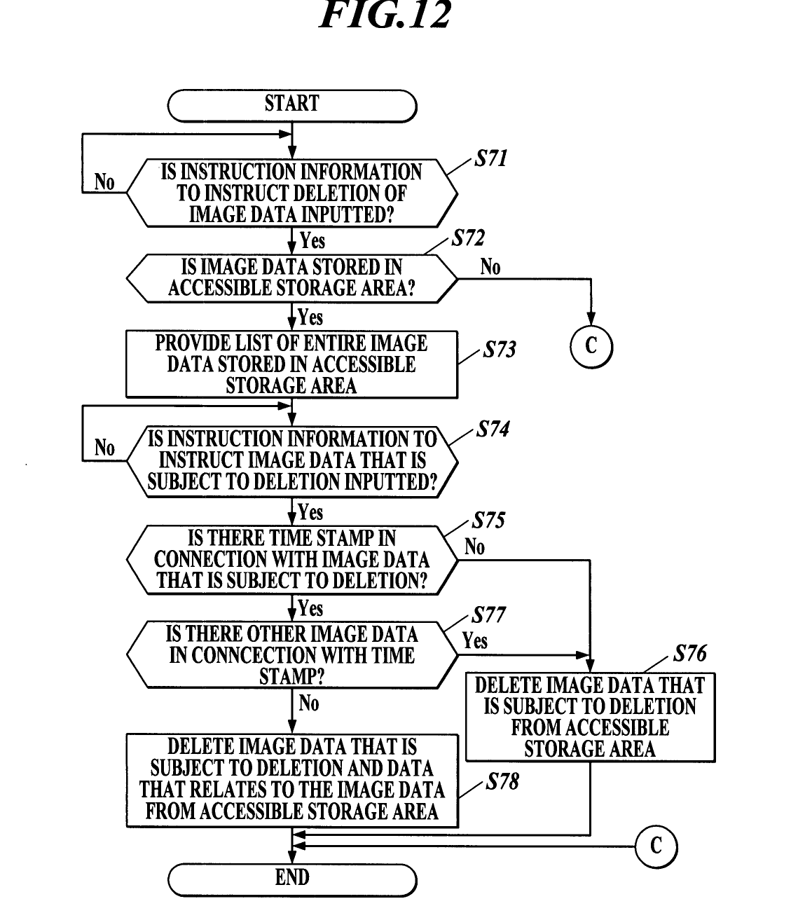

Next, procedure of image data deletion processing according to the present embodiment will be described with reference to FIG. 12. Here, each of the processing within the image data deletion processing indicates processing that is executed by collaboration of predetermined program stored in the memory unit 13, under the control of the control unit 10.

First of all, the control unit 10 conducts standby until instruction information to conduct deletion of image data stored in the accessible storage area 132 is inputted from the operation unit 11 and the like (step S71; No). Then, in a case where the control unit 10 affirms that this instruction information is inputted (step S71; Yes), it determines whether image data is stored in the accessible storage area 132 of the memory unit 13 or not. In a case where it is determined that image data is not stored in the accessible storage area 132 (step S72; No), the present processing is concluded immediately.

On the other hand, in a case where it is determined in step S72 that image data is stored in the accessible storage area 132 (step S72; Yes), the control unit 10 provides a list of all the image data stored in the accessible storage area 132, in a form that is referable by the user, such as by displaying it on the display unit 12 (step S73).

Subsequently, the control unit 10 conducts standby until instruction information to instruct a particular image data that is subject to deletion, among the list of image data provided to the user in a referable manner (step S74; No). Then, in a case where input of this instruction information is affirmed (step S74; Yes), the control unit 10 determines whether time stamp is provided in connection with the image data that is subject to deletion or not. In a case where it is determined that time stamp is not provided in connection (step S75; No), this image data is deleted from the accessible storage area 132 (step S76), and the present processing is concluded.

On the other hand, in a case where it is determined in step S75 that time stamp is provided in connection with the image data that is subject to deletion (step S75; Yes), the control unit 10 further determines whether other image data is stored in connection with this time stamp or not (step S77).

In a case where it is determined in step S77 that other image data is stored in connection with this time stamp (step S77; Yes), it moves on to step S76, deletes image data that is subject to deletion from the accessible storage area 132 (step S76), and concludes the present processing.

On the other hand, in a case where it is determined in step S77 that other image data is not stored in connection with this time stamp (step S77; No), the control unit 10 deletes image data that is subject to deletion as well as data that relates to the image data subject to deletion (time stamp and hash value), from the accessible storage area 132 (step S78), and concludes the present processing. Therefore, since individual hash value and time stamp that became needed can be deleted, memory capacity can be used efficiently.

As described above, one time stamp that relates to the entire electronic data is obtained in accordance with the hash value that is calculated from the entirety of individual hash value for each of the electronic data, and this time stamp is stored in connection with the individual hash value. Therefore, even in a case where image data is deleted, hash value that relates to obtaining of time stamp that is in connection with the image data can be calculated.

Here, in the afore-mentioned image data deletion processing, image data that is selectable so as to be subject to deletion may be restricted in accordance with the user identification information inputted from the user. In such case, it is preferable that the system administrator is capable to select all of the image data, that is stored in the accessible storage area 132, to be subject to deletion, and it is preferable that the general user is capable to select image data, that relates to the user identification information of this general user, to be subject to deletion.

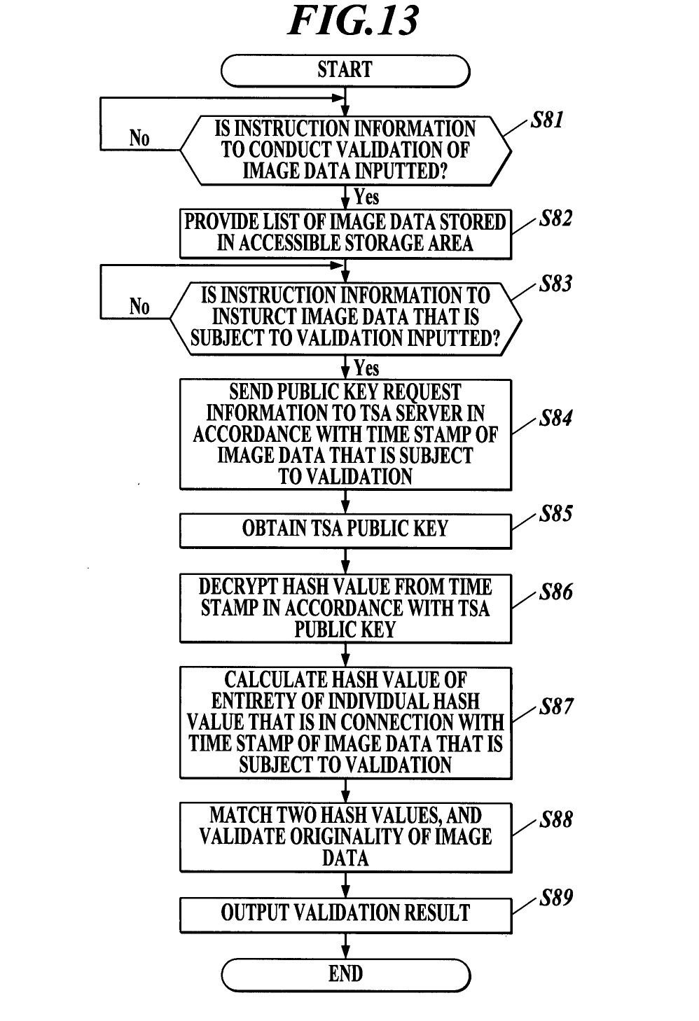

Next, procedure of data validation processing according to the present embodiment will be described with reference to FIG. 13. Here, each of the processing within the data validation processing indicates processing that is executed by collaboration of predetermined program stored in the memory unit 13, under the control of the control unit 10.

First of all, the control unit 10 conducts standby until instruction information to conduct validation of job is inputted from the operation unit 11 and the like (step S81; No). Then, in a case where the control unit 10 affirms that the instruction information is inputted (step S81; Yes), list of image data that is stored in the accessible storage area 132 of the memory unit 13 is provided in a manner so as to be referable by the user, such as by displaying it on the display unit 12 (step S82).

Subsequently, the control unit 10 conducts standby until instruction information to specify image data that is subject to validation is inputted from the operation unit 11 and the like (step S83; No). Then, in a case where the control unit 10 affirms that instruction information is inputted (step S83; Yes), the control unit 10 sends public key request information (step S84) to request TSA public key to the TSA server 3, which is the destination information included in the time stamp of the image data that is subject to validation. Thus, TSA public key is obtained from this TSA server 3 (step S85).

The control unit 10 decrypts hash value (step S86) from the time stamp of the image data that is subject to validation, by the obtained TSA public key, as well as re-calculates hash value (step S87) by applying hash function to the entirety of the individual has value that is in connection with this time stamp. Then, the control unit 10 validates originality of the image data that is subject to validation (step S88) by matching these two hash values. The validation result is outputted in a manner that is referable by the user (step S89), through the display unit 12, the image forming unit 21, and the like, and the present processing is concluded.

As described above, since the electronic data stored in connection with the time stamp is validated in accordance with the time stamp, time certification of the entire image data can be conducted at one time.

As described above, according to the present embodiment, one time stamp that relates to the entire image data is obtained in accordance with the hash value that is calculated from one or the entirety of a plurality of image data that is stored in the non-accessible storage area 131. Therefore, time stamp that relates to a plurality of image data can be obtained efficiently, and thus time and cost required to obtain time stamp can be reduced.

Here, in a case where printing of image data stored in the accessible storage area 132 is instructed by the user, the afore-mentioned data validation processing may be conducted together. In such case, validation result of the image data may be outputted in an overlapped manner with the image that is print outputted. Further, in a case where it is determined as a result of validation that originality is not maintained, it may be controlled so as not to conduct printing.

Further, in the present embodiment, in a case where validation of a particular image data is instructed individually from the user, validation may be conducted by re-calculating individual hash value for the image data that is subject to validation, and comparing this re-calculated individual hash value and the individual hash value that is stored in connection with the time stamp.

Concerning the detail structure and specific performance of the image forming apparatus according to the afore-mentioned embodiment, they can be modified so long as it does not deviate the scope of the present invention.

For example, in the above embodiment, time stamp was obtained from the TSA server 3. However, it is not limited to such embodiment, and in a case where the MFP 1 itself has a structure that generates time stamp, time stamp generated by the MFP 1 may be stored in connection with each job.

In addition, in the afore-mentioned embodiment, MFP which is a multifunctional peripheral was given as an example, however, it is not limited to such embodiment. For example, it may be applied to single functional peripheral such as a printer apparatus which is a single function printer (SFP), scanner apparatus, and the like, and information processing apparatus such as file server and the like.

In the afore-mentioned embodiment, and example in which image data was used as electronic data was given, however, it is not limited to such embodiment. For example, it can be applied to data such as video data and audio data.

In the afore-mentioned embodiment, non-accessible storage area and accessible storage area were provided in one memory unit that is housed in the MFP 1, however, it is not limited to such embodiment. For example, each of the storage area may be provided to a different memory unit respectively, or may be provided to an external storing apparatus which is outside the MFP 1.

The time stamp obtaining apparatus and the time stamp obtaining method according to the present invention can be realized by an exclusive hardware circuit to execute each of the afore-mentioned procedure, and also by the control unit (CPU) executing a program that describes each of the afore-mentioned procedure. In a case where the present invention is realized by the latter, the afore-mentioned program that operates the time stamp obtaining apparatus may be provided by a recording medium that is computer readable, such as floppy (registered) disk, CD-ROM, and the like. It may also be provided on-line through a network such as internet and the like. In such case, program that is recorded on the computer readable recording medium is usually transferred and stored in a recording medium such as ROM, hard disk, and the like. Further, this program may be provided as a single application software, or may be incorporated in a software of a time stamp obtaining apparatus as one function of the apparatus.

As described, according to the afore-mentioned embodiment, since one time stamp that relates to the entire electronic data is obtained in accordance with a hash value that is calculated from one or the entirety of a plurality of electronic data, time stamp that relates to a plurality of electronic data can be obtained efficiently, and thus time and cost required to obtain time stamp can be reduced.

According to the afore-mentioned embodiment, hash value for the entire electronic data, that have been stored until the predetermined time, is calculated, and one time stamp that relates to the entire electronic data is obtained in accordance with this hash value. Therefore, time stamp that relates to a plurality of electronic data can be obtained efficiently, and thus time and cost required to obtain time stamp can be reduced.

According to the afore-mentioned embodiment, hash value for the entire electronic data, that have been stored until instruction information to instruct obtaining of time stamp is inputted from external, is calculated, and one time stamp that relates to the entire electronic data is obtained in accordance with this hash value. Therefore, convenience of the user can be provided as well as time stamp that relates to a plurality of electronic data can be obtained efficiently, and thus time and cost required to obtain time stamp can be reduced.

According to the afore-mentioned embodiment, electronic data that is not in connection with a time stamp is extracted, and hash value for the entirety of this extracted electronic data is calculated. Therefore, redundant obtaining of time stamp can be prevented, and thus time and cost required to obtain time stamp can be reduced.

According to the afore-mentioned embodiment, electronic data that is not in connection with time stamp is controlled so that access from external is prohibited. Therefore, operation such as falsification or deletion of data before time stamp is obtained, can be prevented.

According to the afore-mentioned embodiment, in a case where instruction information to instruct obtaining of time stamp that relates to a particular electronic data is inputted from external, hash value for the entire electronic data that is specified by the instruction information is calculated, and one time stamp that relates to the entirety of the specified electronic data is obtained in accordance with this hash value. Therefore, convenience of the user can be provided as well as time stamp that relates to a plurality of electronic data can be obtained efficiently, and thus time and cost required to obtain time stamp can be reduced.

According to the afore-mentioned embodiment, in a case where instruction information to instruct deletion of a particular electronic data is inputted from external, it is compensated as if the electronic data that is instructed to be deleted is deleted. Therefore, convenience of the user can be provided. In addition, since hash value can be re-calculated for the entire electronic data that is in connection with this time stamp, from the electronic data that is instructed to be deleted and other electronic data that is in connection with the time stamp which is in common with the electronic data that is instructed to be deleted, the entire image data can be validated in accordance with this hash value.

According to the afore-mentioned embodiment, in a case where all electronic data that is in connection with one time stamp is compensated as if they are deleted, this time stamp and all the electronic data that is in connection with the time stamp is deleted. Therefore, since electronic data and time stamp that became unneeded are deleted, memory capacity can be used efficiently.

According to the afore-mentioned embodiment, one time stamp that relates to the entire electronic data is obtained in accordance with a hash value that is calculated from the entirety of individual hash value for each electronic data, and this time stamp is stored in connection with the individual hash value. Therefore, even in a case where image data is deleted, hash value that relates to obtaining of time stamp which is in connection with the image data can be calculated.

According to the afore-mentioned embodiment, in a case where instruction information to instruct deletion of a particular electronic data is inputted from external, the specified electronic data is deleted. Therefore, convenience of the user can be provided.

According to the afore-mentioned embodiment, in a case where all the electronic data that is I connection with the one time stamp are deleted, the time stamp and all the individual hash value that is in connection with the time stamp is deleted. Therefore, since individual hash value and time stamp that became unneeded can be deleted, memory capacity can be used efficiently.

According to the afore-mentioned embodiment, electronic data that is stored in connection with the time stamp is validated in accordance with the time stamp. Therefore, time certification of the entire electronic data can be conducted at one time.

The present U.S. patent application claims a priority under the Paris Convention of Japanese patent application No. 2006-62761 filed on Mar. 8, 2006, and shall be a basis of correction of an incorrect translation.

What is claimed is:

1. A time stamp obtaining apparatus comprising a memory unit and a control unit, wherein the control unit conducts a control to:
calculate one first hash value from one or a plurality of electronic data among electronic data stored in the memory unit;
obtain one first time stamp that relates to the one or the plurality of electronic data, from which the first hash value is calculated, in accordance with the first hash value; and
store the first time stamp in connection with the one or the plurality of electronic data that relates to calculation of the first hash value, in the memory unit.

2. The time stamp obtaining apparatus of claim 1, wherein the control unit:
extracts electronic data that is not in connection with a time stamp, among the electronic data stored in the memory unit; and
calculates a second hash value for entirety of the electronic data that is not in connection with the time stamp that is extracted.

3. The time stamp obtaining apparatus of claim 1, wherein the control unit controls so that electronic data that is not in connection with a time stamp, among the electronic data stored in the memory unit, cannot be accessed from external.

4. The time stamp obtaining apparatus of claim 1, wherein the control unit:
obtains one second time stamp that relates to entirety of the electronic data stored in the memory unit, in accordance with a third hash value that is calculated from entirety of individual hash value for each of the electronic data stored in the memory unit; and
the second time stamp is stored in the memory unit in connection with the individual hash value.

5. The time stamp obtaining apparatus of claim 4, wherein in a case where instruction information to instruct deletion of a particular electronic data is inputted from external, the control unit deletes electronic data that is instructed to be deleted from the memory unit.

6. The time stamp obtaining apparatus of claim 5, wherein in a case where all electronic data that is in connection with the first or the second time stamp is deleted, the first or the second time stamp and the first hash value or all of the individual hash value that are in connection with the first or the second time stamp are deleted from the memory unit.

7. A time stamp obtaining method comprising:
first calculation step to calculate one first hash value from one or a plurality of electronic data among electronic data stored in a memory unit;
first obtaining step to obtain one first time stamp that relates to the one or the plurality of electronic data, from which the first hash value is calculated, in accordance with the first hash value; and
first storing step to store the first time stamp in connection with the one or the plurality of electronic data that relates to calculation of the first hash value, in the memory unit.

8. The time stamp obtaining method of claim 7, further comprising:
extraction step to extract electronic data that is not in connection with a time stamp, among the electronic data stored in the memory unit; and
second calculation step to calculate a second hash value for entirety of the electronic data that is not in connection with the time stamp that is extracted.

9. The time stamp obtaining method of claim 7, wherein electronic data that is not in connection with a time stamp, among the electronic data stored in the memory unit, cannot to be accessed from external.

10. The time stamp obtaining method of claim 7, further comprising:
second obtaining step to obtain one second time stamp that relates to entirety of the electronic data stored in the memory unit, in accordance with a third hash value that is calculated from entirety of individual hash value for each of the electronic data stored in the memory unit; and
second storing step to store the second time stamp in the memory unit in connection with the individual hash value.

11. The time stamp obtaining method of claim 10, wherein in a case where instruction information to instruct deletion of a particular electronic data is inputted from external, electronic data that is instructed to be deleted is deleted from the memory unit.

12. The time stamp obtaining method of claim 11, wherein in a case where all electronic data that is in connection with the first or the second time stamp is deleted from the memory unit, the first or the second time stamp and the first or all of the individual hash value that are in connection with the first or the second time stamp, are deleted from the memory unit.

13. The time stamp obtaining method of claim 7, wherein validation of electronic data that is stored in connection with a time stamp is conducted in accordance with the time stamp.

14. A computer readable recording medium stored with a program, said program causing a computer to execute a process comprising:
first calculation step to calculate one first hash value from one or a plurality of electronic data among electronic data stored in a memory unit;
first obtaining step to obtain one first time stamp that relates to the one or the plurality of electronic data, from which the first hash value is calculated, in accordance with the first hash value; and
first storing step to store the first time stamp in connection with the one or the plurality of electronic data that relates to calculation of the first hash value, in the memory unit.

15. The computer readable recording medium of claim 14, wherein the program executes the process further comprising:
extraction step to extract electronic data that is not in connection with a time stamp, among the electronic data stored in the memory unit; and
second calculation step to calculate a second hash value for entirety of the electronic data that is not in connection with the time stamp that is extracted.

16. The computer readable recording medium of claim 14, wherein the program makes electronic data that is not in connection with a time stamp, among the electronic data stored in the memory unit, unable to be accessed from external.

17. The computer readable recording medium of claim 14, wherein the program executes the process further comprising:
second obtaining step to obtain one second time stamp that relates to entirety of the electronic data stored in the memory unit, in accordance with a third hash value that is calculated from entirety of individual hash value for each of the electronic data stored in the memory unit; and
second storing step to store the second time stamp in the memory unit in connection with the individual hash value.

18. The computer readable recording medium of claim 17, wherein the program, in a case where instruction information to instruct deletion of a particular electronic data is inputted from external, deletes electronic data that is instructed to be deleted from the memory unit.

19. The computer readable recording medium of claim 18, wherein the program, in a case where all electronic data that is in connection with the first or the second time stamp is deleted from the memory unit, deletes the first or the second time stamp and the first or all of the individual hash value that are in connection with the first or the second time stamp, from the memory unit.

20. The computer readable recording medium of claim 14, wherein the program conducts validation of electronic data stored in connection with a time stamp in accordance with the time stamp.
